(19) United States
(12) Patent Application Publication
(10) Pub. No.: US 2006/0042493 A1
(43) Pub. Date: Mar. 2, 2006

(54) Winding way of typing, typesetting or writing to print

(76) Inventor: Steve Sanghoo Kim, Des Plaines, IL (US)

Correspondence Address: Steve S. Kim, APT 201, 1480 Jefferson ST., Des Plaines, IL, 60016, US

(21) Appl. No.: 10/927,855

(22) Filed: Aug. 27, 2004

(51) Int. Cl. G03G 15/32

(52) U.S. Cl. 101/494

(57) ABSTRACT

People have a fixed idea or type or write and reading are only one direction likely from left to right. However, there is no problem to do that reverse direction also if the letters or words are arranged in the order with reverse way. So, I invented TYPING AND PRINTING FOR WINDING WAY READING by arranging letters or words in reverse order of each line against to the previous line in the page, and the first letter of each line starts right below and closest place from the last letter or character of the previous line for ALL LANGUAGES. This is similar to farmers crop there corns both directions to save time and costs. MY WINDING WAY READING may give to readers big benefits to save time and avoid eyes tiring to bring back their eyes all the way left side to find and read every next line.

### CROSS- REFERENCE TO RELATED APPLICATION

NOT APPLICABLE

### STATEMENT REGARDING FEDERALLY SPONSORED RESERCH OR DEVELOPMENT

NOT APPLICABLE

### REFERENCE TO SEQUENCE LISTING, A TABLE, OR A COMPUTER

NOT APPLICABLE

### BACKGROUND OF THE INVENTION

When I attended a class in 1992, an instructor wrote lecture contents on the blackboard very fast and erased soon. So, I had no time to come back to all the way left side of my notebook. To save time, I started writing for next line at the right below and closest place from the last letter of the previous line, and I wrote from right to left reversibly for every other line continually. Then, I saved time, and I had no problem to read the notebook again. Recently 2004, I found and realized that if all books are printed can be read by both directions which means every line started right below and closest place from the last letter or character of the previous line and arranged to left or right of all letters or words, then readers may save a lot of time and avoid eyes tire to find and read every next line. To provide for this both directions reading what I called WINDING WAY READING, people can use existing typewriter or computer or develop computer software for better work. Publishers may have better business also because of readers' faster and comfortable reading may reduce time to buy next book.

### BRIEF SUMMARY OF THE INVENTION

I found that people have a fixed idea to type or write and reading is one direction only likely from left to right. However, there is no problem to read any letter or word by reverse direction also, and typing or writing can be provided for this both directions' reading by existing system or computer software developing for better work. My new TYPING AND PRINTING FOR WINDING WAY READING is that publishers provide both directions reading by arranging letters or words in reverse order against to the previous lines. Every first letter or character starts right below and closest place from the last letter or character of the previous line so that immediate connecting to next line. So, people can read books smoothly from left to right and right to left continually instead of their eyes bring back to all the way left side without doing anything to find and read next line. By this new way reading, readers may save a lot of times and avoid eyes tire. Publishers may have better business, because readers can read their books faster and comfortably and reduce time to buy next book. Publishers may have less broken words and save spaces by typing longer lines, especially very short lines of newspapers. This WINDING WAY READING is similar to farmers crop corns both directions with tractors to save time and costs.

### BRIEF DESCRIPTION OF THE SEVERAL VIEWS OF THE DRAWING

NOT APPLICABLE

### DETAILED DESCRIPTION OF THE INVENTION

No farmers plow their farm from east to west only with tractors. They plow their farm from east to west and west to east of both directions to save time and costs. To recognize any object which having shape, there is little difference to look at it from and to any direction. Those things let me find WINDING WAY READING to save reader's time and avoid their eyes' tire. The first line of the letters or words may be arranged by existing(regular) direction. But, second line's starting letter or character starts right below and closest place from the one of the previous line, and we arrange letters or words in the reverse direction can be read both direction. We continue this way. For this winding way reading, we can use existing typewriter or computer, or we can develop computer software for better work.

[image]

This TYPING AND PRINTING FOR WINDING WAY READING may be applicable to all languages.

I claim:

1. Typing and printing providing for the both directions reading by arranging letters or words of each line in reverse order against to the previous line, and the first letter or character starts right below and closest place from the last letter or character of the previous line which can be read without any reading gap in stead of reader's eyes bring back to the all the way left side with wasting time and eyes tire to find and read every next line through the page for all languages.
